(19) United States
(12) Patent Application Publication
(10) Pub. No.: US 2025/0245823 A1
(43) Pub. Date: Jul. 31, 2025

(54) SYSTEMS AND METHODS FOR DETECTING HERBICIDE-RESISTANT WEEDS

(71) Applicants: Pauline Victoria Allasas Estrada, Fresno, CA (US); John Benedict Allasas Estrada, Fresno, CA (US)

(72) Inventors: Pauline Victoria Allasas Estrada, Fresno, CA (US); John Benedict Allasas Estrada, Fresno, CA (US)

(21) Appl. No.: 19/076,913

(22) Filed: Mar. 11, 2025

Related U.S. Application Data
(63) Continuation-in-part of application No. 18/313,780, filed on May 8, 2023.
(60) Provisional application No. 63/563,464, filed on Mar. 11, 2024.
(60) Provisional application No. 63/339,418, filed on May 7, 2022.
(60) Provisional application No. 63/339,420, filed on May 7, 2022.
(60) Provisional application No. 63/339,421, filed on May 7, 2022.
(60) Provisional application No. 63/339,422, filed on May 7, 2022.

(51) Int. Cl. G06T 7/00; G06V 10/764; G06V 10/82; G06V 20/10

(52) U.S. Cl. CPC G06T 7/0012; G06V 10/764; G06V 10/82; G06V 20/188; G06T 2207/10036; G06T 2207/20081; G06T 2207/20084; G06T 2207/30188

(57) ABSTRACT

An herbicide-resistant weed identifier program may be developed using a neural network model to identify herbicide resistance in weeds, particularly common chickweed plants. A camera may be used to capture full spectrum images of plants which may be used to develop and train the neural network model. The present invention provides a classification model which can accurately identify herbicide-resistant weeds expeditiously and reliably, even before any visible symptoms of herbicide injury are present in a plant.

### CROSS-REFERENCE TO RELATED APPLICATIONS

This application is a continuation-in-part of U.S. Nonprovisional patent application Ser. No. 18/313,780, filed May 8, 2023, which claimed priority to, and the benefit of U.S. Provisional Patent Application Nos. 63/339,418, 63/339,420, 63/339,421, and 63/339,422, each filed May 7, 2022 and each of which are hereby incorporated by reference in their entirety. This application also claims priority to, and the benefit of, U.S. Provisional Patent Application Nos. 63/563,464 and 63/770,212, filed Mar. 11, 2024, and Mar. 11, 2025, respectively, each of which are hereby incorporated by reference in their entirety.

### FIELD OF THE INVENTION

The present invention concerns systems and methods for detecting herbicide-resistant weeds from camera images. More particularly, embodiments of the present invention concern a neural network classification model trained using camera-captured images and which can identify herbicide resistance in weeds using spectral data.

### BACKGROUND OF THE INVENTION

Herbicide-resistant weeds (also known as “superweeds”) pose a significant threat to crop production and food security. Globally, farmers lose more than $95 billion annually from uncontrolled weeds. Some conventional methods of identifying herbicide-resistant weeds, genetic sequencing and herbicide dose-response studies, are expensive and time-consuming processes. However, the failure to detect herbicide-resistant weeds early in the crop growing season can lead to significant economic losses and severe environmental damage.

Herbicides are chemicals used to manipulate or control weeds or unwanted plants. They are extensively used in agriculture, forestry, and landscaping. However, studies have shown that there are many negative issues associated with the increasing use of herbicides. For example, herbicides can contaminate streams and ground water, and kill non-target plants and animals, as well as beneficial insects like pollinators. Recent studies have shown that colony collapse disorder (CCD), which has caused decimation of entire hives of bees, is also related to increasing herbicide use.

Exposure to herbicides has also been linked to several health problems, including cancer, reproductive and neurological problems, as well as decreased neurobehavioral performance in adolescents. Farmers and other people who work with herbicides are at a greater risk since they have more exposure to herbicides. Also, downstream exposure of herbicides to people living in surrounding neighborhoods and end consumers of crop products are also affected.

Reliance on, and continuous use of, herbicides in controlling weeds can lead to rapid evolution of herbicide-resistant weed populations. Recent data shows that there are 530 unique cases of herbicide-resistant weeds, globally. Herbicide-resistant weeds require the use of higher doses and application of alternative herbicides (or multiple herbicides) to be effective, which further increase farming costs and risks to human health and the environment.

Herbicide resistance is becoming a big problem particularly in California—the food basket of the world. There are now 56 cases of herbicide resistance observed in the U.S., 30 of which are in California. Most of these cases are evolved resistance to acetolactate synthase (ALS) or 5-enolpyruvylshikimate 3-phosphate (EPSPS) inhibiting herbicides. The occurrence of ALS herbicide resistance to more weed species is continuously rising at an alarming rate posing a greater challenge for weed management, food production, and environmental health. Furthermore, documented cases of ALS herbicide resistance in different weed species are significantly higher than for any other class of agricultural herbicides.

Common chickweed (Stellaria media) is a broad leaf annual weed species commonly found in agricultural fields infesting wheat, triticale, barley, and several other annual and perennial crops. It is a widespread and very successful weed since it adapts and survives well in different environmental conditions. Overuse and reliance on a single herbicide to control common chickweed for extended periods has led to the evolution of herbicide-resistant populations. Over time, common chickweed has developed resistance to ALS herbicides. ALS inhibitors, a specific type of Group 2 herbicide, prevent the ALS enzyme from functioning properly. This is due to mutations in the ALS gene leading to altered herbicide binding sites which make the enzyme less sensitive to inhibition by the herbicide.

The first herbicide-resistant common chickweed to three different ALS herbicides in California was reported in 2022. Target-site resistance (TSR) is the most common type of herbicide resistance in common chickweed and has been reported in all major herbicide classes, including glyphosate, ALS inhibitors, and triazines. Sulfonylurea and imidazolinone herbicides are both linked to target-site resistance in common chickweed. Over the past three decades, resistance to these two ALS herbicides was observed in common chickweed biotypes. However, it has not been confirmed yet if the ALS-resistant common chickweed has a target-site resistance mechanism.

The effect of ALS inhibition in susceptible weeds includes disruption of photosynthesis transport and respiration system which leads to chlorophyll degradation. Stress or disruption in the transport chain due to the application of ALS herbicide can be detected by measuring changes in the chlorophyll light absorption, reflectance patterns, and chlorophyll fluorescence. All vegetation, including weeds, have distinct light reflectance patterns which can be measured and graphed using a spectrometer. This is called its “spectral signature.” Healthy thriving plants have a very different spectral signature when compared to stressed, diseased, or unhealthy plants. Different weed species have unique spectral signature changes depending on their resistance or susceptibility to herbicides which may fall within or outside the visible light spectrum. Herbicide-resistant kochia (Bassia scoparia) and common waterhemp (Amaranthus tuberculatus) weeds have spectral signatures in infrared (IR) regions (>750 nm) while common ragweed (Ambrosia artesiifolia) has a spectral signature in the wavelengths of 450-630 nm.

Different approaches have been developed to try to confirm herbicide-resistant weed populations. The standard and the most accepted methods are the use of genetic sequencing, which detects/confirms resistant genes or genes in weeds, and/or herbicide dose-response studies. These methods are very accurate but can be time and labor-intensive, as well as costly procedures. A newer conventional technique uses Spectral Weed Indices (SWIs) to try to identify glyphosate-resistant weeds. For common waterhemp, this method uses reflectance values from eight relevant spectral wavelengths to develop the different SWIs: 490 nm, 760 nm, 520 nm, 820 nm, 850 nm, 910 nm, 880 nm, and 790 nm. The method, however, requires the use of a proprietary and expensive apparatus, labor-intensive pre-processing of data, and very complex calculations.

Other techniques include the use of unmanned aerial vehicle (UAV)-acquired thermal and multispectral response of weeds. These techniques use web mapping software for raster and spectral classification to differentiate herbicide-resistant weeds from susceptible ones. It has, however, been shown that the use of thermal data is not as reliable as the use of the Normalized Difference Vegetation Index (NDVI).

While previous conventional techniques have applied convolutional neural networks (CNN) to detect weeds using red, green, and blue (RGB) images, these techniques have not realized the potential of utilizing full spectrum (ultraviolet+visible+near infrared wavelengths) images acquired through readily available converted, off-the-shelf consumer cameras to detect herbicide-resistant weeds.

The present invention solves the above issues, among others, by providing an herbicide-resistant weed classification model which can distinguish herbicide-susceptible weeds from herbicide-resistant weeds. The present invention is particularly well suited for use with common chickweed (Stellaria media), which is an emerging major problem in California crops.

### BRIEF SUMMARY OF THE INVENTION

The present invention provides an herbicide-resistant weed classification model which can accurately identify herbicide-resistant weeds expeditiously and more reliably than conventional means, and in particular, the present invention provides for early, quick, and accurate detection and classification of herbicide-resistant weeds, even before observing the visible symptoms of herbicide injury. In one embodiment, the present invention can be practiced using a low-cost, readily available consumer camera that can be converted to capture full spectrum imagery. Full spectrum imagery can capture subtle differences in the spectral signature of herbicide-treated plants to determine whether a particular herbicide-treated plant is predicted to be resistant to an herbicide, in part because it allows all possible areas of differences in spectral signatures to be used in the classification model's accurate differential analysis.

In some embodiments, the present invention may utilize a convolutional neural network (CNN) model in herbicide-resistant weed identification which provides timely interventions and establishes cost-effective environmentally friendly management strategies. The present invention may allow farmers to develop more effective and safer weed management practices. The present invention may also result in the reduction of herbicide use, thereby minimizing environmental harm and improving public health.

According to some embodiments of the present invention, a system for classifying herbicide-resistant weeds (in particular, common chickweed) may comprise a camera configured to capture the full spectrum of light, from about 300 nm to about 1,100 nm. In some embodiments, full spectrum images of common chickweed plants may be obtained and used to develop a convolutional neural network (CNN) model, preferably using a “train from scratch” approach. According to some embodiments, a hyperparameter tuner algorithm may be utilized to optimize the model's accuracy and an early stopping function may be used to prevent model overfitting.

According to some embodiments of the present invention, an herbicide-resistant weed classification system may identify weeds that are resistant to some acetolactate synthetase (ALS) inhibitor herbicides as early as 72 hours after herbicide treatment at an accuracy of about 88%. The present invention has broad applicability due to the ability to distinguish resistant from susceptible common chickweed regardless of the ALS herbicide chemical group or dosage rate applied.

In accordance with some embodiments of the present invention, a method for determining the probability of resistance of a weed to an herbicide may comprise the steps of: creating an herbicide-resistant weed classification model; obtaining a full spectrum image file of the weed; providing the image file to the model; and, from the model, generating the probability of resistance associated with such weed. In some embodiments, the weed may be common chickweed. In some embodiments, the herbicide may comprise an acetolactate synthase inhibitor. In some embodiments, the image file may comprise spectral information of wavelengths from about 300 nm to about 1,100 nm. In some embodiments, the step of creating the model may comprise the steps of, for each of a plurality of training weeds: applying an herbicide to the training weed; acquiring a full spectrum image of the training weed; and classifying the training weed as herbicide-resistant or not herbicide-resistant; wherein the plurality of training weeds may comprise a first set of training weeds that may be confirmed to be resistant to the herbicide and a second set of training weeds that may not be confirmed to be resistant to the herbicide. In some embodiments, the step of applying the herbicide may occur after the training weed has grown to at least about 7.5 mm in height and has at least two true leaves. In some embodiments, the step of acquiring the image may occur about 3 days after the herbicide is applied to the training weed. In some embodiments, the step of classifying the training weed as herbicide-resistant may be made with reference to whether the training weed was grown from a seed obtained from a known herbicide-resistant weed. In some embodiments, the step of classifying the training weed as herbicide-resistant may be made about 28 days after the herbicide is applied to the training weed, and the training weed may be classified as not herbicide-resistant if it is not visually observed to have growing green tissue, and wherein the training weed may be classified as herbicide-resistant if is visually observed to have growing green tissue. In some embodiments, the step of creating the model may comprise training the model with, for each training weed, the full spectrum image of the training weed and an indication of the classification of whether the training weed may be herbicide-resistant or not herbicide-resistant. In some embodiments, each training weed may be common chickweed, and the herbicide may comprise an acetolactate synthase inhibitor and may comprise one of the group consisting of imazamox, imazethapyr, mesosulfuron-methyl, pyroxsulam, and tribenuron-methyl. In some embodiments, the model may comprise a hyperparameter-tuned convolutional neural network with an early stopping function. In some embodiments, the model may comprise about four convolutional 2D layers and about 10 dense neural net layers. In some embodiments, the model may be created from at least about 1,500 data points, where each datapoint may correspond to a unique one of the plurality of weeds.

In accordance with some embodiments of the present invention, a method for determining whether a common chickweed plant is resistant to an acetolactate synthase inhibitor herbicide may comprise the steps of applying the herbicide to the plant, then waiting about three days, then obtaining a full spectrum image of the plant containing wavelengths between about 300 nm to about 1,100 nm, and then providing that image to a hyperparameter-tuned convolutional neural network with an early stopping function to obtain therefrom a probability that the plant is herbicide-resistant. In some embodiments, the convolutional neural network model may be trained by a plurality of unique training points, each training point consisting of (i) a full spectrum image of a test common chickweed plant obtained about three days after application of the herbicide to the test plant and (ii) an indication of whether the test plant was grown from a seed obtained from a known herbicide resistant weed.

In accordance with some embodiments of the present invention, a method of calculating a probability that a plant is resistant to an herbicide may comprise providing the spectral signature of light reflectance from the plant to a hyperparameter-tuned convolutional neural network with an early stopping function, wherein the convolutional neural network may be trained with a plurality of training points, wherein each training point may consist of (i) a spectral signature of light reflectance from a unique training plant and (ii) a determination of whether the training plant was resistant to the herbicide. In some embodiments, the spectral signature of the plant may be obtained about three days after the herbicide is applied to the plant, and wherein the spectral signatures of each of the training plants may be obtained about three days after the herbicide is applied to the test plant. In some embodiments, at least one of the plurality of training plants may be produced from seedlings that are resistant to the herbicide. In some embodiments, the plant may be common chickweed, each of the training plants may be common chickweed, and the herbicide may comprise an acetolactate synthase inhibitor.

### BRIEF DESCRIPTION OF THE FIGURES

FIG. 1 is a diagram illustrating an overview of an exemplary method for identifying and classifying herbicide-resistant weeds, in accordance with some embodiments of the present invention.

FIG. 2 is a diagram illustrating an exemplary process for developing and training an herbicide-resistant weed classification model.

FIG. 3 is a printout of an exemplary program used to import a dataset of full spectrum images, in accordance with some embodiments of the present invention.

FIG. 4 a diagram illustrating exemplary training and validation accuracy and loss curves for an exemplary herbicide resistance weed classification model, in accordance with some embodiments of the present invention.

### DETAILED DESCRIPTION OF THE INVENTION

The invention, in its various aspects, will be explained in greater detail below. While the invention will be described in conjunction with several exemplary embodiments, the exemplary embodiments themselves do not limit the scope of the invention. Similarly, the exemplary illustrations in the accompanying drawings, where like elements have like numerals, do not limit the scope of the exemplary embodiments and/or invention, including any length, angles, or other measurements provided. Rather the invention, as defined by the claims, may cover alternatives, modifications, and/or equivalents of the exemplary embodiments.

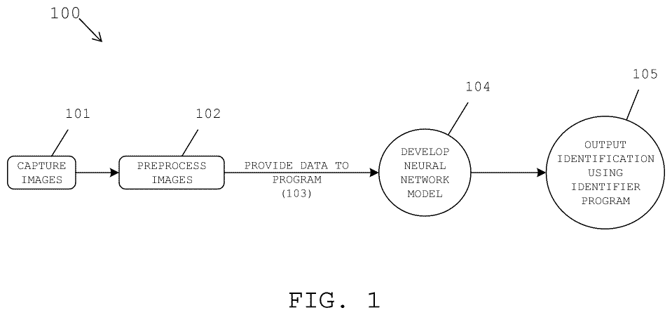

In some aspects, the present invention provides for a method of identifying herbicide-resistant weeds. An overview of an exemplary method 100 for identifying a weed as herbicide-resistant or herbicide-susceptible is illustrated in FIG. 1. First, according to step 101, a plurality of images of weeds may be captured using a camera. Next, according to step 102, the images may be pre-processed (e.g., transformed, manipulated, and/or augmented) before they are used in the development of an herbicide-resistant weed classification model. Once the images have been converted to usable image data, or have otherwise been optimized for use, the data may be provided to a software program to be used in the development of the herbicide-resistant weed classification model, according to step 103. Next, and with reference to step 104, the herbicide-resistant weed classification model may be constructed (i.e., trained and validated). Following, and with reference to step 105, once the herbicide-resistant weed classification model has been developed, an herbicide-resistant identifier program running the herbicide-resistant weed classification model may output an identification of herbicide resistance in a weed.

### Configuring a Camera to Capture the Full Light Spectrum

According to some embodiments of the present invention, a system for classifying herbicide-resistant weeds may include one or more cameras, preferably, without a hot mirror filter (which filters out ultraviolet (UV) and infrared (IR) light) in order to allow the camera sensor to capture the full light spectrum, including UV and near-IR wavelengths, along with the visible light spectrum. A hot mirror filter is a dichroic filter typically placed in the camera between an optical sensor and a light source, the purpose of which is to reflect IR light and allowing visible light to pass. In some embodiments, a camera may also be equipped with a normalized difference vegetation index (NDVI) filter and a hot mirror filter to also capture NDVI and regular RGB images. Utilizing a camera which can capture the full spectrum of light (300 nm-1,100 nm) allows for the inclusion of a spectral signature in the images of common chickweed which is crucial in the differential analysis of the herbicide-resistant weed classification model.

### Obtaining Full Spectrum Images for the Development of an Herbicide-Resistant Weed Classification Model

In one implementation of the present invention, high-resolution, full-spectrum images of common chickweed plants treated with different group 2 (ALS) herbicides at different dosage rates may be obtained using a camera configured as described above. Exemplary ALS herbicides used on herbicide-resistant and susceptible common chickweed plants and exemplary dosage rates are summarized in Table 1 below.

TABLE 1

| | | Application Time |
|---|---|---|
| | Dosage Rate | Days After |
| | (x = recommended | Transplanting |
| Herbicides | label rate) | (DAT) |
| Simplicity ™ | 0.5x, 1x, 2x, | 10 |
| (Triazolopyrimidines: | 4x & 8x | |
| Pyroxulam) | | |
| Express ™ (Sulfonylureas: | 0.5x, 1x, 2x, | 10 |
| Tribenuron-methyl) | 4x & 8x | |
| Osprey ™ (Sulfonylureas: | 0.5x, 1x, 2x, | 10 |
| Mesosulfuron-methyl) | 4x & 8x | |
| Beyond ™ (Imidazolinones: | 0.5x, 1x, 2x, | 10 |
| Imazamox) | 4x & 8x | |
| Pursuit ™ (Imidazolinones: | 0.5x, 1x, 2x, | 10 |
| ammonium salt of imazethapyr) | 4x & 8x | |

In some embodiments, captured full-spectrum images (in some embodiments, “full spectrum” refers to wavelengths in the range of 300-1,100 nm) of susceptible and herbicide-resistant common chickweed plants may be used for the development of an herbicide-resistant weed classification model. According to some embodiments, full spectrum, NDVI, and RGB images may be obtained after herbicide treatment. Full spectrum images may be obtained using a camera equipped without NDVI and hot mirror filters. In some embodiments, NDVI and RGB images may be obtained by applying an NDVI and/or hot mirror filters to the full spectrum image. Full spectrum, NDVI, and RGB images may be obtained at, preferably, 1, 2, and 3 days after the application of different herbicides. In preferred embodiments, images obtained at 3 days after herbicide treatment may be used for training and validation of the classification model.

In some embodiments, herbicide-resistant or susceptible classifications of common chickweed plants may be based on a survival evaluation, which may be done about 28 days after applications of ALS herbicides. Common chickweed plants which may be found dead upon evaluation may be classified as susceptible, whereas plants with any green tissue remaining and which are still growing may be classified as herbicide-resistant weeds based on visual observation.

### Development of an Herbicide-Resistant Weed Classification Model Using Full Spectrum Images

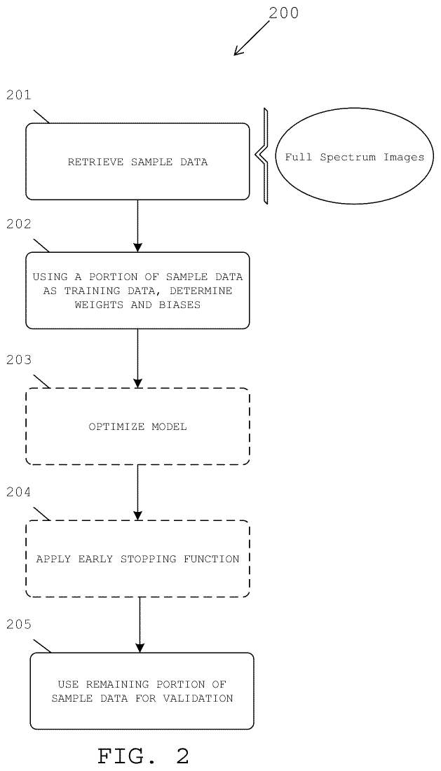

FIG. 2 illustrates an exemplary process 200 for developing an herbicide-resistant weed classification model. In a first step 201, sample data may be obtained for training the model. In some embodiments, the sample data may include a plurality of plant images. For example, full spectrum (i.e., about 300-1,100 nm), straight-out-of-camera (SOOC) (i.e., unprocessed) JPEG images taken, preferably, at about 3 days after herbicide application, may be classified and separated into two groups—herbicide-resistant and herbicide-susceptible. Images from both groups may then be uploaded to a software program and used to develop a CNN classification model.

According to some embodiments, an herbicide-resistant weed classification model may be, preferably, programmed on Google Colab using Python 3.10, running TensorFlow 2.17, with the Keras API. A “sequential” model with, preferably, four convolutional 2D and ten neural net layers may be constructed using ADAM as an optimizer, rectified linear unit (ReLU), hyperbolic tangent (tanh), and sigmoid as an activation function, and sparse categorical cross entropy loss as a loss function. Metrics that may be used in the model are training and validation accuracy, as well as training and validation loss.

In some embodiments, a hyperparameter tuner algorithm may be incorporated into the program to create a CNN model with optimal accuracy and reliability. According to some embodiments, an early stopping protocol through best epoch detection may be used to prevent model overfitting.

Coding the Herbicide-Resistant Weed Identifier Program which Outputs a Prediction of Susceptible or Herbicide-Resistant Common Chickweed

In accordance with some embodiments of the present invention, an herbicide-resistant weed identifier program may be programmed on Google Colab using Python 3.10, running TensorFlow 2.17 (Google, LLC, Mountain View, CA, USA), with the Keras API. To check the classifying ability and accuracy of the CNN model, an image of a susceptible chickweed plant, which was not included in the training and validation dataset, may be uploaded in the herbicide-resistant weed classification output program running the CNN model.

In accordance with some embodiments of the present invention, full spectrum images of herbicide-susceptible and herbicide-resistant weeds (e.g., common chickweed plants) may be captured using a camera configured as described herein. In some embodiments, a total of about 1,000 to about 2,000 images of herbicide-resistant and herbicide-susceptible plants may be imported by the program and used to develop and to train the herbicide-resistant weed classification model. In preferred embodiments, a total of about 1,500 images may be used. FIG. 3 illustrates an exemplary importation of full spectrum images from a data file.

In accordance with some embodiments of the present invention, the Keras data augmentation program may be used to improve the training process by augmenting captured images by rotating and flipping the images into optimal positions before the construction of the CNN model. For example, images may be optimized by augmentation and rotating the images such that the objects thereof (e.g., weeds) are all oriented, generally, in the same direction. In some embodiments, augmented images may be used to construct, train, and validate the CNN model.

According to some embodiments, a neural network may be designed as a sequential algorithm. With further reference to FIG. 2, in step 202, a portion of the collected sample data may be used as training data to determine weights and biases. For example, and according to some embodiments, about eighty percent (80%) of the total collected images (e.g., 1,500) may be used as a training data set and the remaining about twenty percent (20%) may be used as a validation data set. Following step 202, in step 203, the herbicide-resistant weed classification model may be optimized. For example, and in accordance with some embodiments, a hyperparameter tuning library (e.g., KerasTuner) may be used to determine the CNN model with the most “optimal settings”. Use of a hyperparameter tuning library in the development of an herbicide-resistant weed classification model may enhance the learning process and identify optimal hyperparameter combinations to arrive at the best possible classification model.

According to some embodiments of the present invention, and with reference to step 204 of FIG. 2, for example, an early stopping function may be incorporated into the program to prevent overfitting. In one exemplary embodiment, 54 epochs were needed out of a planned 100 epochs before an early stopping function was activated. In this exemplary embodiment, the best hyperparameter combinations and the “optimal model” (best performing CNN model) were generated at 54 epochs. In another exemplary embodiment, the herbicide-resistant weed classification model demonstrated optimal performance at 36 epochs without overfitting.

Once the model has been trained, it may be tested on the remaining sample data to verify accuracy, according to step 205 of FIG. 2. For example, and in accordance with some embodiments, a trained CNN model may be tested on the remaining 20% of image data to assess the model's ability to classify and differentiate susceptible plants from herbicide-resistant common chickweed plants. Training and validation accuracy may be used to evaluate the model's performance.

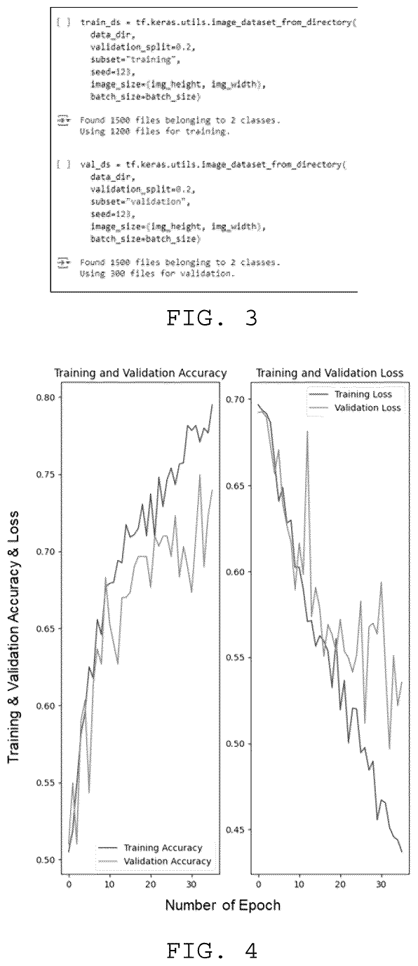

Exemplary training and validation accuracy curves for an herbicide-resistant weed classification model exhibited a steady increase over 54 epochs. Additional exemplary training and validation accuracy curves for an herbicide-resistant weed classification model exhibited a steady increase over 36 epochs, as illustrated, for example, in FIG. 4. The set of hyperparameters used in the model may render a remarkably high validation accuracy and very high training accuracy. The model is very accurate in differentiating and classifying susceptible plants from herbicide-resistant plants. In an exemplary instance, both training loss and validation loss curves for an herbicide-resistant weed classification model showed decreasing values and the accuracy curves showed steadily increasing values with optimal gaps between them indicating optimal learning without overfitting, as further illustrated, for example, in FIG. 4.

A steadily decreasing trend in a training loss curve suggests that the herbicide-resistant weed classification model is improving its learning from the data it was trained on. The very low validation value also showed that the model had achieved “optimal learning”. Model performance on unseen data/images may be evaluated using validation loss. A very low validation loss value achieved in the model may indicate that its error on unseen images is very low, and that the model is accurate in distinguishing herbicide-resistant from susceptible weeds.

An herbicide-resistant weed identifier program may be developed and appended to a newly developed herbicide-resistant weed classification model. A full spectrum image of a susceptible plant not previously input (i.e., not part of the validation set) into the model may be used for secondary verification of accuracy using the herbicide-resistant weed identifier program running the herbicide-resistant weed classification model. In one exemplary instance, the herbicide-resistant weed identifier program was able to independently classify the full spectrum image as a “susceptible” common chickweed plant with an 85.03% accuracy. In another exemplary instance, the herbicide-resistant weed identifier program was able to independently classify the full spectrum images correctly at about an 88% accuracy. In one instance, the performance of the herbicide-resistant weed identifier program in identifying both herbicide-resistant and susceptible common chickweed plants was equally high with classification accuracies of 87.50% and 88.24%, respectively. In one exemplary instance, the herbicide-resistant weed identifier program was able to accurately identify an herbicide-resistant common chickweed plant from full spectrum image with 85.64% accuracy.

The development of an herbicide-resistant weed classification model involves a “train from scratch” approach. This ensures that the model will learn effectively and allow it to learn from a dataset that had been fully vetted, in some embodiments, via a completed dose response study. This approach may also eliminate biases from pre-existing knowledge and pre-trained weights which may be encountered in “transfer learning” approaches.

The use of a hyperparameter tuner program is helpful in determining the best hyperparameter combinations that leads to the development of the best performing herbicide-resistant weed classification model. It can also boost the performance of the model and improve its accuracy, precision, and recall.

Utilization of full spectrum images to develop the herbicide-resistant weed classification model is more robust and more accurate as compared to using RGB or NDVI images. Higher training and validation accuracy are observed on a CNN model that is trained using full spectrum images compared to a model rendered using NDVI or RGB images. This could be due to the inclusion of visible light spectrum (380-750 nm) as well as ultraviolet (UV) (<380 nm) and near-infrared (IR) wavelengths (750-1000 nm) in the full spectrum images which reveal details that are invisible to the human eye or standard camera image sensors. While near-IR wavelengths can show signs of stress in plants even before it becomes visible to the naked eyes as the unhealthy leaf starts to absorb more photos, the visible light spectrum including far-red light can reveal minute changes in the level of photosynthetic activity. RGB wavelength reflectance in plants indicates the amount of red and blue light being absorbed as utilized through photosynthesis and the degree of green light spectrum reflected correlating with the concentration of chlorophyll. As the plant sustains injury and stress from the herbicide, it is unable to absorb as many red and blue light wavelengths. This results in a flattening of the injured plant's spectral signature in the visible light range, as opposed to the usual peaked curve observed in healthy plants with the crest in the green wavelength and troughs in both the red and blue spectra. Some embodiments of the present invention consider the differences in the spectral signature between an injured plant and a health plant.

ALS herbicide injury symptoms, which include chlorosis, stunting, red leaf veins, and tissue necrosis, may be evident in 1-4 weeks after herbicide application depending on the dose and environmental conditions at the time of application. However, the effect of the ALS herbicides on the common chickweed plants may be detected earlier (e.g., 72 hours after herbicide application) by the herbicide-resistant weed identifier program. This is primarily due to the ability of the camera to obtain full spectrum images and capture the spectral signature of common chickweed plants, with varying degrees of ALS injury symptoms, even before they were visible (since the camera can capture wavelengths outside the visible spectrum). A model in accordance with some embodiments of the present invention has the ability to detect herbicide-resistant chickweed plants that are consistent for both target site and non-target site resistance as a result of training using full spectrum images of all resistant plants, regardless of the type of resistance. The present invention supports that light reflectance can effectively detect herbicide injury symptoms like chlorosis within 72 hours. In contrast, dose response studies take at least 2 months to be completed and the fastest genetic sequencing analysis can take a minimum of 2 weeks to obtain results.

The use of different ALS herbicides and varying dosage treatments allows the model to better distinguish herbicide-resistant from herbicide-susceptible plants. This is because the images used to train the model include a wide array or spectrum of injury symptoms from the application of different ALS herbicides and various dosage rates (for example, 0.5x-8x, where x=recommended label rate, illustrated in Table 1). Thus, the model is optimized to categorize common chickweed which has been treated with various types of herbicides and/or dosage rates.

### Future Applications

It is to be appreciated that an herbicide-resistant weed identifier program running an herbicide-resistant weed classification model, according to some embodiments of the present invention, may be integrated into a custom-built autonomous ground-based remotely operated vehicle (ROV) or remotely operated vehicle enhanced receiver (ROVER) to detect and dispose of herbicide-resistant weeds in real-time. For example, the present invention may be integrated with the remotely operated vehicle described in U.S. patent application Ser. No. 18/313,780 by the same inventors and which is incorporated by reference in its entirety. It is also to be appreciated that an herbicide-resistant weed classification model, according to some embodiments of the present invention, may be trained or re-trained on images obtained under field conditions. It is further to be appreciated that an herbicide-resistant weed classification model, according to some embodiments of the present invention, may be used and re-trained for other weed species such as, but not limited to, Palmer amaranth and common water hemp.

It is to be understood that variations, modifications, and permutations of embodiments of the present invention may be made without departing from the scope thereof. It is also to be understood that the present invention is not limited by the specific embodiments, descriptions, or illustrations or combinations of either components or steps disclosed herein. Thus, although reference has been made to the accompanying figures, it is to be appreciated that these figures are exemplary and are not meant to limit the scope of the invention.

Moreover, in this document, relational terms, such as second, top and bottom, and the like may be used solely to distinguish one entity or action from another entity or action without necessarily requiring or implying any actual such relationship or order between such entities or actions. The terms “comprises”, “comprising”, “has”, “having,” “includes”, “including”, “contains”, “containing”, or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises a”, “has . . . a”, “includes . . . a”, “contains . . . a” does not, without more constraints, preclude the existence of additional elements of the same type in the process, method, article, or apparatus that comprises, has, includes, contains the element. The terms “a” and “an” are defined as one or more unless explicitly stated otherwise herein. The terms “substantially”, “essentially”, “approximately”, “about”, or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed. Also, the term “exemplary” is used as an adjective herein to modify one or more nouns, such as embodiment, system, method, device, and is meant to indicate specifically that the noun is provided as a non-limiting example.

What is claimed is:

1. A method for determining the probability of resistance of a weed to an herbicide comprising the steps of:
a) creating an herbicide-resistant weed classification model;
b) obtaining a full spectrum image file of said weed;
c) providing said image file to said model; and
d) from said model, generating said probability of resistance associated with such weed.

2. The method of claim 1, wherein said weed is common chickweed.

3. The method of claim 2, wherein said herbicide comprises an acetolactate synthase inhibitor.

4. The method of claim 1, wherein said image file comprises spectral information of wavelengths from about 300 nm to about 1,100 nm.

5. The method of claim 1, wherein said step of creating said model comprises the steps of, for each of a plurality of training weeds:
i) applying an herbicide to said training weed;
ii) acquiring a full spectrum image of said training weed; and
iii) classifying said training weed as herbicide-resistant or not herbicide-resistant;
wherein said plurality of training weeds comprises a first set of training weeds that are confirmed to be resistant to said herbicide and a second set of training weeds that are not confirmed to be resistant to said herbicide.

6. The method of claim 5, wherein said step of applying said herbicide occurs after said training weed has grown to at least about 7.5 mm in height and has at least two true leaves.

7. The method of claim 5, wherein said step of acquiring said image occurs about 3 days after said herbicide is applied to said training weed.

8. The method of claim 5, wherein said step of classifying said training weed as herbicide-resistant is made with reference to whether the training weed was grown from a seed obtained from a known herbicide resistant weed.

9. The method of claim 8, wherein said step of classifying said training weed as herbicide-resistant is made about 28 days after said herbicide is applied to said training weed, and wherein said training weed is classified as not herbicide-resistant if it is not visually observed to have growing green tissue, and wherein said training weed is classified as herbicide-resistant if it is visually observed to have growing green tissue.

10. The method of claim 5, wherein said step of creating said model comprises training said model with, for each said training weed, said full spectrum image of said training weed and an indication of said classification of whether said training weed is herbicide-resistant or not herbicide-resistant.

11. The method of claim 5, wherein each said training weed is common chickweed, and wherein said herbicide comprises an acetolactate synthase inhibitor and comprises one of the group consisting of imazamox, imazethapyr, mesosulfuron-methyl, pyroxsulam, and tribenuron-methyl.

12. The method of claim 5, wherein said model comprises a hyperparameter-tuned convolutional neural network with an early stopping function.

13. The method of claim 12, wherein said model comprises about four convolutional 2D layers and about 10 dense neural net layers.

14. The method of claim 12, wherein said model is created from at least about 1,500 data points, each said datapoint corresponding to a unique one of said plurality of weeds.

15. A method for determining whether a common chickweed plant is resistant to an acetolactate synthase inhibitor herbicide comprising the steps of applying said herbicide to said plant, then waiting about three days, then obtaining a full spectrum image of said plant containing wavelengths between about 300 nm to about 1,100 nm, and then providing that image to a hyperparameter-tuned convolutional neural network model with an early stopping function to obtain therefrom a probability that said plant is herbicide-resistant.

16. The method of claim 15, wherein said convolutional neural network model is trained by a plurality of unique training points, each said training point consisting of (i) a full spectrum image of a test common chickweed plant obtained about three days after application of said herbicide to said test plant and (ii) an indication of whether said test plant was grown from a seed obtained from a known herbicide-resistant weed.

17. A method of calculating a probability that a plant is resistant to an herbicide comprising providing the spectral signature of light reflectance from said plant to a hyperparameter-tuned convolutional neural network with an early stopping function, wherein said convolutional neural network is trained with a plurality of training points, each said training point consisting of (i) a spectral signature of light reflectance from a unique training plant and (ii) a determination of whether said training plant was resistant to said herbicide.

18. The method of claim 17, wherein the spectral signature of said plant is obtained about three days after said herbicide is applied to said plant, and wherein the spectral signatures of each of said training plants are obtained about three days after said herbicide is applied to said test plant.
